(19) United States
(12) Patent Application Publication
(10) Pub. No.: US 2010/0038386 A1
(43) Pub. Date: Feb. 18, 2010

(54) FLEXIBLE PACKAGE WITH EXTENDABLE DISPENSING SPOUT

(75) Inventor: Barry Pritchard, Nazareth, PA (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: FRES-CO SYSTEM USA, INC., Telford, PA (US)

(21) Appl. No.: 12/193,343

(22) Filed: Aug. 18, 2008

(51) Int. Cl. B67D 3/00; B65D 30/16; B65D 30/20

(52) U.S. Cl. 222/522; 383/104; 383/120; 222/530; 222/538; 222/105

(57) ABSTRACT

Flexible packages for holding and selectively dispensing flowable materials therefrom. Each package is formed of a flexible material and includes an extendable fitment mounted in a wall portion of the package. The extendable fitment includes a movable mounting member, e.g., an evertable member or a slidable member, and a spout or tap mounted thereon. The spout/tap is arranged to be moved from a retracted position wherein at least a portion of it is located within the package to an extended position wherein at least a portion of it is located outside of the package. The spout/tap is arranged to selectively dispense the flowable material from the package it is in its extended position.

### CROSS REFERENCE TO RELATED APPLICATIONS

“Not Applicable”

### STATEMENT REGARDING FEDERALLY SPONSORED RESEARCH OR DEVELOPMENT

“Not Applicable”

### INCORPORATION-BY-REFERENCE OF MATERIAL SUBMITTED ON A COMPACT DISK

“Not Applicable”

### BACKGROUND OF THE INVENTION

1. Field of Invention

This invention relates generally to flexible packaging and more particularly to flexible packages including an extendable spout or tap arranged for extension from the package to enable the selected dispensing of a flowable material from the package.

2. Description of Related Art

Numerous patents disclose flexible packing for holding liquids and for dispensing the liquid through a fitment outlet or tap forming a portion of the package. For example, U.S. Pat. No. 4,429,810 (Hample et al.) discloses a pouch for containing wine, with the pouch including a dispensing valve fitment. U.S. Pat. No. 3,696,969 (De Van et al.), U.S. Pat. No. 4,314,654 (Gaubert), U.S. Pat. No. 4,416,395 (Gaubert), U.S. Pat. No. 4,602,725 (Malpas et al.), U.S. Pat. No. 6,131,767 (Savage et al.), and U.S. Pat. No. 6,446,845 (Steiger) disclose dispensing taps for “bag in box” containers.

Another tap for controlling liquid flow from a bag in a box arrangement is disclosed in International Application WO 01/02283A1.

U.S. Pat. No. 4,452,378 (Christine) discloses a gusseted bottom pouch for containing a liquid, with the pouch including a spout including cap for enabling the contents to drained from the pouch.

U.S. Pat. No. 5,911,340 (Uematsu) and U.S. Pat. No. 6,612,466 (Malin)disclose boat shaped spout assemblies for flexible packages. U.S. Pat. No. 6,050,451 (Hess III, et al.) and U.S. Pat. No. 6,273,307 (Gross et al.) disclose boat shaped valved fitments for flexible packages.

While the aforementioned packages with fitments for containing and dispensing liquids and the fitments for use in such packages may be generally suitable for their intended purposes, they suffer from one or more of the drawbacks, e.g., the fitment extends substantially beyond the surface of the package, thereby precluding the close packing of plural packages next to one another. This is a considerable drawback since shelf space in retail establishments as well as in the home is at a premium.

### BRIEF SUMMARY OF THE INVENTION

This invention relates to flexible packages, e.g., gusseted packages, stand-up pouches, etc., for holding and selectively dispensing a flowable material, e.g., a liquid, therefrom. Each package basically comprises a hollow body and an extendable fitment. The hollow body is formed of a flexible sheet material and has a hollow interior in which the flowable material is located and at least one wall portion bounding the hollow interior. The extendable fitment comprises a tap or spout and a movable mounting member, with the tap or spout being mounted on the movable mounting member. The movable mounting member is connected to said at least one wall portion and is arranged to be moved from a retracted position wherein at least a portion of the spout or tap is located within the hollow interior of the package to an extended position wherein at least a portion of the spout or tap is located outside of the hollow interior of the package. The spout or tap is arranged to selectively dispense the flowable material from the hollow interior of the package when the spout or tap is in the extended position.

In accordance with one preferred aspect of this invention the movable mounting member is arranged to enable one to move the tap or spout from a retracted position to the extended position and vice versa.

In accordance with one preferred embodiment of this invention the movable mounting member is evertable. In accordance with another preferred embodiment the moveable mounting member is slidable.

In accordance with one preferred method aspect of this invention, the packages of this invention are formed of a flexible material by means of an automated form, fill and seal machine.

### BRIEF DESCRIPTION OF SEVERAL VIEWS OF THE DRAWINGS

The invention will be described in conjunction with the following drawings in which like reference numerals designate like elements and wherein:

FIG. 1A is an isometric view of one exemplary embodiment of a gusseted type flexible package having an extendable spout or tap fitment constructed in accordance with this invention, with the spout or tap fitment being shown in its fully retracted position;

FIG. 1B is an isometric view, like that of FIG. 1A, but showing the package with its spout or tap fitment extended to its extended operative position, whereupon the contents of the package can be dispensed through the spout or tap fitment;

FIG. 2A is an enlarged view partially in section taken along line 2A-2A of FIG. 1A;

FIG. 2B is an enlarged view partially in section taken along line 2B-2B of FIG. 1B;

FIG. 3A is an isometric view of an exemplary embodiment of a stand-up pouch type flexible package having an extendable spout or tap fitment constructed in accordance with this invention, with the spout or tap fitment being shown in its fully retracted position;

FIG. 3B is an isometric view, like that of FIG. 3A, but showing the package with its spout or tap fitment extended to its operative position, whereupon the contents of the package can be dispensed through the spout or tap fitment;

FIG. 4A is a partial sectional view, similar to FIG. 2A, but showing an alternative embodiment of an extendable spout or tap fitment constructed in accordance with this invention in its retracted position; and

FIG. 4B is a partial sectional view, like that of FIG. 4A, but showing the spout or tap fitment extended to its extended operative position, whereupon the contents of the package can be dispensed through the spout or tap fitment.

### DETAILED DESCRIPTION OF THE INVENTION

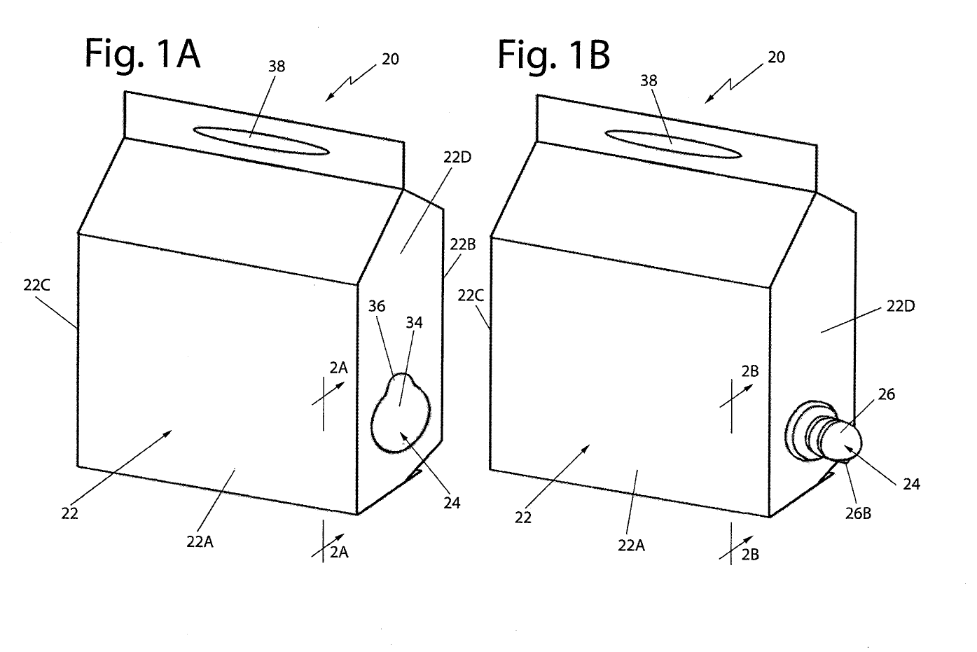

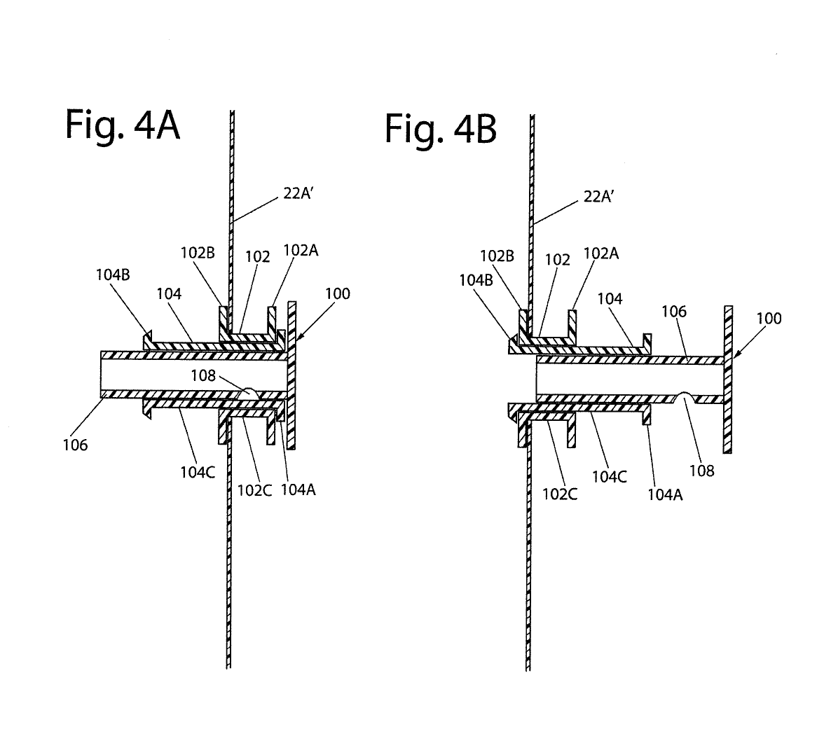

In FIG. 1A there is shown at 20 one exemplary embodiment of a package for holding and dispensing a flowable material, e.g., a liquid, a powder, a particulate, etc. The package 20 basically comprises a flexible bag 22 and an extendable spout or tap fitment 24. The fitment is in the form of an assembly. The spout or tap fitment 24 enables the contents of the bag 22 to be selectively dispensed when the spout/tap is in its extended or operative position. When dispensing isn't required, such as when the package is stored on some shelf alone or with other like packages or when it is being transported, the spout/fitment is disposed in its fully retracted state. In this state (retracted position) the spout/fitment is either fully located within the bounds of the package (as is the case of the embodiments shown in FIGS. 1A, 1B, 2A, 2B, 3A and 3B) or primarily located therein, with only a small portion projecting outward (as is the case of the embodiment of FIGS. 4A and 4B).

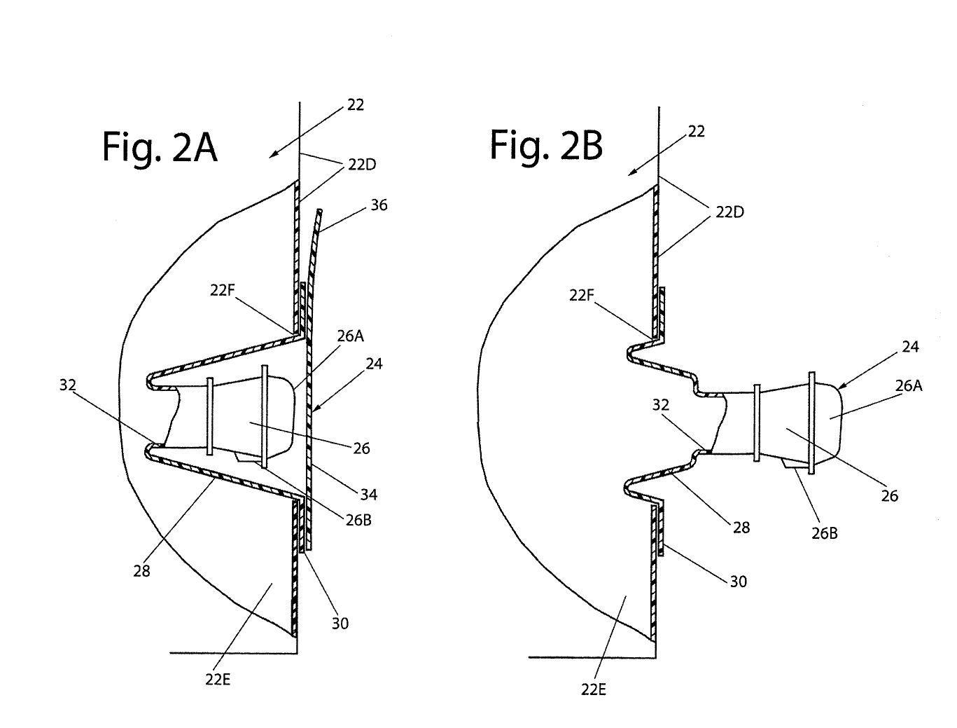

The flexible bag 22 may be in the form of a gusseted bag as shown in FIGS. 1A and 1B, a stand-up pouch as shown in FIGS. 2A and 2B, a pillow-shaped bag (not shown) or any other shaped package formed of a flexible material. The bag 22 may be made by fabricating it from roll stock of flexible film, e.g., polymeric film, and securing the extendable spout or tap fitment assembly 24 to the bag using a conventional fill, form and seal machine.

Irrespective of the construction of the bag 22 it includes at least one wall portion bounding a hollow interior space in which the flowable material is held.

In the embodiment shown in FIGS. 1A and 1B the bag is a gusseted bag 22 having a front panel or wall 22A, a rear panel or wall 22B, a pair of side gussets 22C and 22D, all of which bound a hollow interior space 22E (FIGS. 2A and 2B). The details of the extendable fitment assembly 24 will be described later. Suffice it for now to state that it includes a spout or tap 26 and an extendable mounting member 28 on which the spout or tap is mounted. The mounting member is adapted to be moved from a retracted position, like shown in FIGS. 1A and 2A, to an extended position, like shown in FIGS. 1B and 2B, and vice versa. In the embodiment of FIGS. 1A, 1B, 2A, 2B and 3A and 3B, the mounting member is formed of any suitable flexible material that is readily evertable. The member 28 is in the form of a conical cup-shaped body having a peripheral flange 30 at one end. The member 28 is mounted within a hole 22F in any wall of the bag 22 where the fitment is desired to be located. In the exemplary embodiment shown that is wall 22D. The hole corresponds in shape and size to the profile of the member 28, e.g., is circular.

The flange 30 is arranged to be fixedly secured to the outer surface of the wall 22D contiguous with the opening 22F so that its conical body extends inward into the hollow interior 22E of the bag as best seen in FIG. 2A. The opposite end of the member 28 from the flange 30 is in the form of a tubular section 32 which merges into the body of the spout or tap so that the hollow interior of the section 32 is in fluid communication with the passageway through the spout or tap.

The spout or tap 26 of the fitment 24 can be of any conventional construction, e.g., it can be tap or spout that includes a button or cap 26A that when pressed allows a flowable material to flow out of port 26B in the spout or tap. Alternatively, it may be twist-to-open spout or tap, such as that disclosed in U.S. Pat. No. 7,246,721, whose disclosure is incorporated by reference herein.

In order to close off the space in which the spout/tap 26 is located when it is in its retracted position, and also to provide a smooth appearance for the bag 22, the bag 22 includes a removable (peel-off) dust cover 34 releasably adhesively secured to the flange 30 of the member 28. The dust cover 34 includes a pull tab 36 to facilitate peeling it off the bag when it is desired to gain access to the spout/tap 26. When the cover 34 is in place the extendable spout or tap will be concealed and the wall of the bag in which it is located will appear uninterrupted, i.e., smooth and continuous.

When it is desired to dispense some or all of the contents of the bag 22 all that is required is to peel off the cover 34 and to pull outward on the spout or tap 26 to extend it to its extended position. To facilitate such action the spout or tap 26 may include a pull ring or grip bar on it. In any case, pulling outward on the spout or tap will cause the flexible mounting member 28 to evert from its normal state as shown in FIG. 2A to its extended state as shown in FIG. 2B, whereupon the spout or tap 26 will be located beyond the outer surface of the wall 220 of the bag in which it was initially disposed. The spout or tap can then be operated to dispense contents of the bag.

As shown in FIGS. 1A and 1B, the bag 22 may include an opening 38 in its top fin portion to serve as a handle for facilitating the lifting of the package.

If it is desired to retract the spout/tap 26 after some of the contents of the package 22 have been dispensed, all that is required is to press on the spout or tap to push it inward, whereupon the mounting member 28 will evert back to its normal retracted state, like shown in FIG. 2A.

In accordance with a preferred aspect of this invention the diameters of the portions of the evertable mounting member 28 and the material making it up are selected so that it will effectively “lock” into the retracted position. By “lock” it is meant that the evertable mounting member will naturally snap-into that position and be somewhat resistant to accidental extension. It will, however, be able to be readily pulled outward by the user to the extended position and when in that position be resistant to accidental movement until sufficient force is applied to it to push it back to the retracted position.

If it is desired, and if the cover 34 includes a reusable adhesive (or if the flange 30 has a reusable adhesive thereon), the cover can be reattached to the bag 22 closing off the interior of the package where the spout/tap will now reside until further use of it is desired.

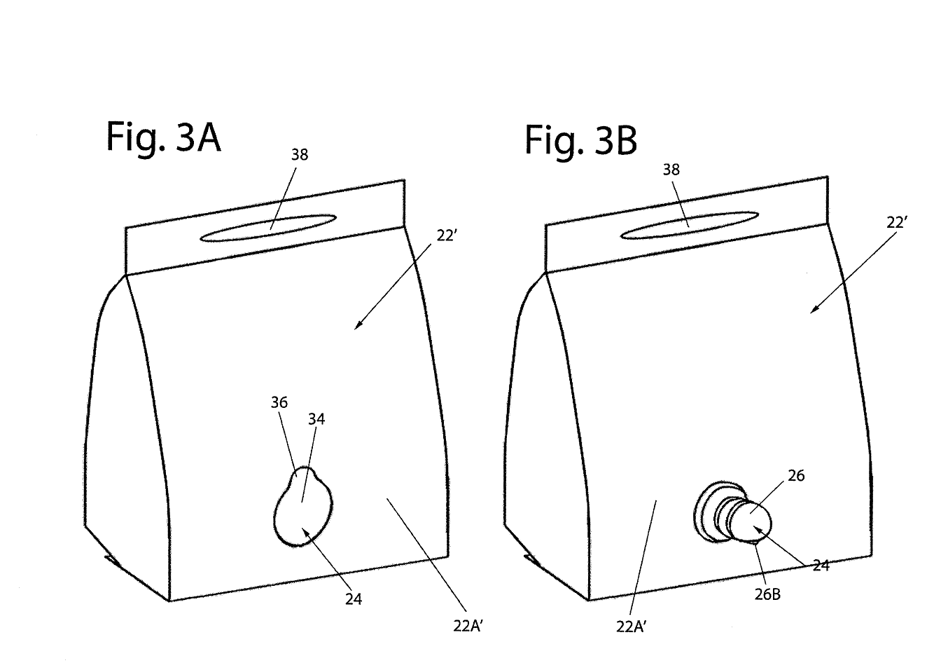

In FIGS. 3A and 3B, there is shown a stand-up pouch 22′ having a front wall panel 22A′ in which an extendable spout or tap fitment assembly 24 like that of FIGS. 1A and 1B is disposed. In the interest of brevity the construction and operation of the assembly 24 will not be reiterated. Suffice to state that it includes the same components and operates in the same way as described heretofore.

In FIGS. 4A and 4B there is shown an alternative embodiment of an extendable spout or tap fitment assembly 100 or constructed in accordance with another aspect of this invention. The spout or tap fitment assembly 100 can be used on a gusseted bag like shown in FIGS. 1A and 1B, or on a stand-up pouch, like shown in FIGS. 3A and 3B, or on any other type of flexible package. In the embodiment shown the fitment assembly 100 is shown disposed in the front panel 22A′ of a stand-up pouch 22′.

The fitment assembly 100 basically comprises a sealing flange 102, an intermediate extension member 104 and a slide valve 106. The sealing flange 102 is a short length tubular member which includes a front flange 102A, a rear flange 102B and an intermediate tubular throat 102C. The sealing flange member 102 is mounted on the pouch 22′ so that its throat 102C extends through a correspondingly shaped opening in the wall 22A′, with the front surface of the rear flange 102A adhesively secured to the inner surface of the pouch wall 22A′ contiguous with that opening. Since the sealing flange is of a short length its front flange 102 will not extend a substantial distance beyond the surface of the pouch's wall 22A′.

The intermediate or extension member 104 basically comprises a tubular member that extends through the hollow interior of the sealing flange and is arranged to be slid (reciprocated) therein. To that end, the outside diameter of the extension member is just slightly less than the inside diameter of the throat of the sealing flange. Thus, the intermediate extension member 104 is slidable from a retracted position shown in FIG. 4A to an extended position shown in FIG. 4B, and vice versa. The intermediate extension member 104 includes a front flange 104A, a rear flange 104B and a tubular body 104C. The front flange 104A is arranged to abut the front flange 102A of the sealing flange member when the extension member is in its normally retracted position. Accordingly, the front flange of the extension member will also not extend a substantial distance beyond the surface of the wall 22A′ when it is in its normal, retracted position.

The slider valve 106 basically comprises a tubular member or body, whose outside diameter is just slightly less than the inside diameter of the intermediate extension member 104. The tubular sidewall of the body of valve 106 includes a port 108 in fluid communication with the hollow interior of the body. The front end of the tubular body is closed off and is in the form of a cap 110. The cap enables the slider valve 106 to be readily grasped and pulled out or pushed in to effect its operation as will be described hereinafter.

As will be appreciated by those skilled in the art, when the intermediate extension member 104 is in its retracted position, like shown in FIG. 4A, and the slider valve 106 is also in its retracted or closed position, the port 108 will be closed off by the inner surface of the extension member 104 covering the port 108, whereupon the contents of the pouch will be precluded from flowing out. When it is desired to dispense some or all of the contents of the pouch 22′, the intermediate extension member 104 can be pulled out by grasping its front flange 104A to bring it to the extended position shown in FIG. 4B. When that has been achieved the cap 110 of the slider valve 106 can be pulled outward to cause the slider valve to slide outward with respect to the now extended intermediate extension member 104, whereupon the port 110 will clear the front flange 104A of the member 104. Accordingly, the contents of the pouch 22′ can begin to flow out of the pouch through the valve. The rear flange 104B of the extension member 104 is arranged to abut the rear flange 102B of the sealing flange member 102 when the extension member 104 is in its fully extended position. This action prevents the intermediate extension member from becoming disconnected from the fitment assembly 100.

When no further dispensing is desired the slider valve 106 can be pushed back by pressing on its cap 110 so that its port 108 is located over the inner surface of the intermediate extension member 104 thereby closing that port. Further pushing on the slider valve's cap causes it to engage the outer surface of the front flange 104A of the intermediate extension member 104, thereby causing that member to slide inward until the front flange of the intermediate extension member abuts the front flange 102A of the sealing flange member 102. At this point the fitment assembly 100 will be in its fully retracted position as shown in FIG. 4A.

As will be appreciated from the foregoing, the subject invention provides an extendable spout or tap which will either take no space beyond the outer surface of the package (as is the case of the embodiments of FIGS. 1A, 1B, 2A, 2B, 3A and 3B), or merely minimal space (as is the case of the embodiment of FIGS. 4A and 4B), thereby rendering the packages of this invention suitable for disposition very close to other such packages with minimal wastage space therebetween.

As mentioned earlier, it the subject packages can be made on a form, fill and seal machine. To that end, such a machine is preferably configured to include a pair of heat sealing jaws to seal the extendable spout assembly (the fitment) to a portion of the film making up one of the walls of the package. A vertical form, fill and seal machine for making and filling “stand-up” pouches having fitments is disclosed in my U.S. Pat. No. 6,182,426, whose disclosure is incorporated by reference herein. That machine can be readily modified to make the packages of this invention. Other types of conventional form, fill and seal machines can be used to make the packages in accordance with this invention.

As is known, a vertical form, fill and seal machine makes use of a web of polymeric film that is pulled downward intermittently in the machine by pairs of transverse (horizontal) sealing jaws. As the film web is drawn downward it is formed into a flat envelope by a forming collar or folder. In particular, the marginal side edges of the web of film are juxtaposed over each other to form a flat tube having a vertical fold line located on the opposite side as the juxtaposed edges. The movement of the folded film envelope is stopped for a short period of time and extendable spout assembly to be secured to the package is brought in between contiguous portions of those juxtaposed edges while the folded film envelope is stationary. A pair of corresponding shaped, vertically oriented, heat sealing jaws are arranged to be brought into engagement with the film envelope on each side of the extendable spout assembly to fixedly secure it in place therebetween. Another pair of opposed, vertically oriented, heat sealing jaws are brought into engagement with the contiguous and unsealed juxtaposed marginal edges of the film envelope for what will become the package to seal those edges and thereby form a film tube. The flattened film tube with the extendable spout assembly now secured to it is then moved downward by the operation of the pairs of transverse sealing jaws. These jaws create the top seal of a preceding package and the bottom seal of the next succeeding package.

In order to fill the packages as they are formed the machine includes a fill tube that extends into the formed film tube and begins to fill the film tube once the bottom seal has been created. The filling of the film tube continues until the film tube has been moved down to the position wherein the transverse pairs of heating jaws seal its top end, while creating the bottom seal of the next successive package.

The top seal of the preceding package is spaced slightly below the bottom seal of the next succeeding package. A horizontally disposed knife blade (not shown) is introduced into the space between the pairs of jaws forming the top and bottom seals to separate the leading (now filled) package from the trailing package, i.e., to sever the film tube between the top seal of the preceding package and the bottom seal of the next succeeding package.

While the invention has been described in detail and with reference to specific examples thereof, it will be apparent to one skilled in the art that various changes and modifications can be made therein without departing from the spirit and scope thereof.

What is claimed is:

1. A flexible package for holding and selectively dispensing a flowable material therefrom comprising a hollow body and an extendable fitment, said hollow body being formed of a flexible sheet material and having a hollow interior in which the flowable material is located and at least one wall portion bounding said hollow interior, said extendable fitment comprising a tap or spout and a movable mounting member, said tap or spout being mounted on said movable mounting member, said movable mounting member being connected to said at least one wall portion and arranged to be moved from a retracted position wherein at least a portion of said spout or tap is located within said hollow interior to an extended position wherein at least a portion of said spout or tap is located outside of said interior of said package, said spout or tap being arranged to selectively dispense the flowable material from said hollow body when said spout or tap is in said extended position.

2. The flexible package of claim 1 wherein said movable mounting member is evertable.

3. The flexible package of claim 2 wherein said package includes an opening in said at least one wall portion in which said evertable member is located.

4. The flexible package of claim 3 additionally comprising a cover releasably mounted over said opening to cover said spout or tap when said spout or tap is in said retracted position.

5. The flexible package of claim 3 wherein said evertable member comprises a flange, said flange being fixedly secured to said wall portion of said package contiguous with said opening.

6. The flexible package of claim 5 additionally comprising a cover releasably mounted over said opening to cover said spout or tap when said spout or tap is in said retracted position.

7. The flexible package of claim 1 wherein said movable mounting member is arranged to be moved from said retracted position to said extended position and vice versa.

8. The flexible package of claim 2 wherein said movable mounting member is arranged to be moved from said retracted position to said extended position and vice versa.

9. The flexible package of claim 1 wherein said movable mounting member comprises a slidable tubular member adapted to be slid with respect to said wall of said package from said retracted position to said extended position.

10. The flexible package of claim 9 additionally comprising a flanged member fixedly secured to said wall of said package and having an opening extending therethrough in which said movable mounting member is disposed to enable said movable mounting member to be reciprocated therein between said retracted position and said extended position and vice versa.

11. The flexible package of claim 10 wherein said spout or tap comprises a tubular member having a port, said tubular member being located within said movable mounting member and arranged to be slid with respect thereto to enable said port to be opened, whereupon the flowable material in said package can flow out of said spout or tap.

12. The flexible package of claim 9 wherein said slidable mounting member is arranged to be slid from said retracted position to said extended position and vice versa.

13. The flexible package of claim 1 wherein said package is a gusseted package.

14. The flexible package of claim 1 wherein said package is a stand-up pouch.
